(19) United States
(12) Patent Application Publication
(10) Pub. No.: US 2012/0213574 A1
(43) Pub. Date: Aug. 23, 2012

(54) METHOD OF FASTENING ARRANGEMENT FOR THE POSITIONALLY CORRECT FASTENING OF A DEVICE TO A STRUCTURAL PART OF A MOTOR VEHICLE

(75) Inventors: Hubert Graf, Oberkirch (DE); Tobias Kraus, Renchen (DE); Frank Griebenow, Rheinau (DE); Michael Mueller, Oberkirch (DE); Hansjoerg Schmeider, Oberkirch (DE); Thorsten Seiler, Renchen (DE); Hans-Peter Thumbach, Renchen (DE); Jakob Willmann, Freiburg (DE)

(73) Assignee: PROGRESS-WERK OBERKIRCH AG, Oberkirch (DE)

(21) Appl. No.: 13/213,246

(22) Filed: Aug. 19, 2011

(30) Foreign Application Priority Data
Aug. 20, 2010 (DE) 10 2010 035 766.9

(51) Int. Cl. F16B 11/00; B32B 37/12; B32B 37/02

(52) U.S. Cl. 403/270; 156/92; 156/73.1

(57) ABSTRACT

In a fastening arrangement for the positionally correct fastening of a device to a structural part of a motor vehicle, the at least one screw means is arranged on a tolerance-compensating part, wherein the tolerance-compensating part is fixed to the structural part by means of a joining material which is selected from an adhesive or a plastic liquefied by ultrasonic welding, and wherein the tolerance-compensating part is adjusted in position relative to the structural part. A method for the positionally correct fastening of a device to the structural part of a motor vehicle makes use of a tolerance-compensating part which is joined to the structural part by making use of a joining process in which a joining material is used, the joining process being selected from the group consisting of: adhesive bonding with an adhesive as the joining material, ultrasonic welding with a plastic as the joining material. The tolerance-compensating part is positionally adjusted relative to the structural part during the joining process through the joining material, and the device is fastened to the tolerance-compensating part via at least one screw.

### CROSS REFERENCES TO RELATED APPLICATION

This application claims priority from German patent application No. 10 2010 035 766.9 filed on Aug. 20, 2010. The entire contents of these priority application is incorporated herein by reference.

### BACKGROUND OF THE INVENTION

The invention relates to a method for the positionally correct fastening of a device to a structural part of a motor vehicle via at least one screw means.

The invention also relates to a fastening arrangement for the positionally correct fastening of a device to a structural part of a motor vehicle via at least one screw means.

A method and a fastening arrangement of the types mentioned at the beginning are generally known.

Without restricting the generality, the method according to the invention and the fastening arrangement according to the invention are described using the example of fastening a head-up display to a cross member, a cross member part or to a holder fastened to the cross member. In this context, the device is accordingly the head-up display and the structural part is the cross member, the cross member part or a holder which is fastened to the cross member.

The cross member of a motor vehicle is located between the two A pillars below the windscreen and serves as a stabilizing part of the motor vehicle body and for the fastening of the steering column, the dashboard and further fittings, for example a head-up display.

To date, a head-up display (HUD) has been fastened to a cross member (part) or to a holder fastened to the cross member by at least two holes being provided in the cross member (part) or in the holder fastened to the cross member, wherein one hole has a screw means, for example a nut, such that the HUD can be fixed to the holder or to the cross member (part) by means of a screw while a centring pin which is connected to the HUD engages in the second hole.

In this known procedure of fastening to the cross member (part) or to the holder fastened to the cross member, it is difficult to adjust the position of the HUD. This is due to the fact that the manufacturing inaccuracies of the cross member or cross member part or of the holder fastened to the cross member, and, in particular, of the holes in the holder or in the cross member (part) may sometimes be of such a size that quite an effort is required in order to fasten the HUD to the holder or to the cross member (part) in a positionally correct manner. Since the HUD is an optical device with which vehicle parameters, for example the actual speed being driven, can be projected onto the windscreen and, owing to reflections on the windscreen, can be read by the driver, the positionally correct positioning of the HUD is particularly important. If the HUD is not correctly oriented, the vehicle parameters may not be projected onto the correct location on the windscreen, and therefore said vehicle parameters are not within the field of view of the driver and therefore the driver cannot read the vehicle parameters, or said vehicle parameters are displayed distorted.

However, the adjustment in position of the HUD in the vehicle during the assembly of the vehicle turns out, as already mentioned above, to be difficult and time-consuming due to manufacturing tolerances in the holder or in the cross member.

### SUMMARY OF THE INVENTION

The invention is therefore based on the object of improving a method and a fastening arrangement of the types mentioned at the beginning to the effect that the positionally correct fastening of the device to the structural part of the motor vehicle becomes simpler and less time-consuming.

According to an aspect, a method for the positionally correct fastening of a device to a structural part of a motor vehicle is provided, comprising the following steps: providing the device; providing the structural part; providing a tolerance-compensating part; joining the tolerance-compensating part to the structural part by making use of a joining process in which a joining material is used, the joining process being selected from the group consisting of: adhesive bonding with an adhesive as the joining material, ultrasonic welding with a plastic as the joining material; positionally adjusting the tolerance-compensating part relative to the structural part during the joining process through the joining material; fastening the device to the tolerance-compensating part via at least one screw.

According to another aspect, a fastening arrangement for the positionally correct fastening of a device to a structural part of a motor vehicle is provided, comprising: a device; a structural part; a tolerance-compensating part fixed to the structural part a joining material which is selected from the group consisting of: an adhesive, a plastic liquefied by ultrasonic welding, the tolerance-compensating part being adjusted in position relative to the structural part by the joining material; at least one screw fastening the device to the tolerance-compensating part.

In the case of the method according to the invention and the fastening arrangement according to the invention, the device is therefore no longer fastened directly to the structural part of the motor vehicle, but rather the device is fastened to a tolerance-compensating part, wherein the tolerance-compensating part is fastened to the structural part of the motor vehicle in a manner adjusted in position. According to the invention, the tolerance-compensating part is fastened to the structural part in a manner adjusted in position by means of a joining process, in which the tolerance-compensating part is adhesively bonded to the structural part by means of an adhesive, or in which the tolerance-compensating part is fixed to the structural part by ultrasonic welding of a plastic which liquefies during the ultrasonic welding and then hardens again. In both cases, manufacturing tolerances of the structural part are compensated for by the joining of the tolerance-compensating part to the structural part in a manner adjusted in position, and therefore the tolerance-compensating part has the correct position and orientation for the fastening of the device. The device is then in the correct position simply by being fastened to the tolerance-compensating part so that a subsequent adjustment in position of the device in the motor vehicle is not required or is at least substantially simplified.

The method according to the invention and the fastening arrangement according to the invention are therefore simpler and less time-consuming with respect to handling.

In a refinement of the method and of the fastening arrangement, the tolerance-compensating part is adjusted in position in at least two directions in space, and, furthermore preferably, the tolerance-compensating part is adjusted in position in all directions in space by additional adjustment of the thickness of the joining material layer.

In the event of the tolerance-compensating part being adhesively bonded to the structural part, the tolerance-compensating part is adjusted in at least two directions in space, for example in the x and y directions (i.e. in one plane), and, furthermore preferably, the thickness of the joining material layer is also adjusted such that, advantageously, manufacturing tolerances on the structural part are compensated for in all three directions in space and the device correspondingly sits in a positionally correct manner in all three directions in space when said device is fastened to the tolerance-compensating part. The thickness of the joining material layer can also be adjusted in a locally varying manner, i.e. the thickness of the joining material layer can be adjusted locally.

In a refinement of the fastening arrangement, the at least one screw means is a thread which is cut or roller burnished into a hole in the tolerance-compensating part.

This affords the advantage of a cost-effective production of the tolerance-compensating part which is designed overall as a single part or single piece.

As an alternative thereto, the at least one screw means can be a sleeve which is provided with an internal thread, which sleeve is inserted into a hole in the tolerance-compensating part or is cast into the latter.

In this refinement, the at least one screw means and the tolerance-compensating part are two parts which do first of all still have to be joined together, but this has the advantage, inter alia, that the tolerance-compensating part itself can be manufactured from plastic while the sleeve can then be manufactured from metal, thus enabling the costs of the tolerance-compensating part to be reduced.

Within the scope of the last-mentioned refinement, it is furthermore preferred if the sleeve has a portion which is inserted into a hole in the structural part, the portion has an outside diameter which is smaller than the inside diameter of the hole in the structural part, and the joining material is also present between the portion of the sleeve and the hole in the structural part.

In this refinement, it is advantageous that, by the sleeve portion being received in the hole in the structural part, the fastening of the tolerance-compensating part to the structural part is mechanically highly stable, this being improved even more by means of the joining material between the portion of the sleeve and the hole in the structural part.

According to a further preferred refinement, the tolerance-compensating part is designed as a substantially flat, plate-like crossbar.

In the simplest case, the tolerance-compensating part is a plane plate which has the at least one screw means, wherein a hole serves to receive a centring pin of the device. In this configuration, the tolerance-compensating part can be produced extremely cost-effectively, for example from metal or else from plastic.

In a further preferred refinement, the tolerance-compensating part has an extension around the at least one screw means, which extension is inserted into a hole in the structural part, wherein the extension has an outside diameter which is smaller than the inside diameter of the hole in the structural part, and wherein the joining material is also present between the extension and the hole in the structural part.

This in turn affords the advantage of a mechanically stable connection of the tolerance-compensating part to the structural part, in particular because the adhesive layer, or the layer of plastic in the case of ultrasonic welding, connects the tolerance-compensating part to the structural part in three directions in space.

As already mentioned, the tolerance-compensating part can be manufactured from plastic or from metal.

The method according to the invention and the fastening arrangement according to the invention are in particular advantageous whenever the device is a Head-up display and/or whenever the structural part is a cross member of a motor vehicle or is a holder which is fastened to the cross member.

Further advantages and features emerge from the description below and from the attached drawing.

It goes without saying that the features mentioned above and those which have yet to be explained below can be used not only in the respectively stated combination but also in different combinations or on their own without departing from the scope of the present invention.

### BRIEF DESCRIPTION OF THE DRAWINGS

Exemplary embodiments of the invention are illustrated in the drawing and will be described in more detail here with reference to the drawings, in which:

FIG. 1 shows a cross-sectional view of a first exemplary embodiment of a fastening arrangement for the positionally correct fastening of a device to a structural part of a motor vehicle;

FIG. 2 shows a cross-sectional illustration of a further exemplary embodiment of a fastening arrangement together with an apparatus for producing the fastening arrangement;

FIG. 3 shows the fastening arrangement from FIG. 2 after the production thereof;

FIG. 4 shows a cross-sectional illustration of a further exemplary embodiment of a fastening arrangement;

FIG. 5 shows a cross-sectional illustration of yet another exemplary embodiment of a fastening arrangement;

FIG. 6 shows a cross-sectional illustration of yet another exemplary embodiment of a fastening arrangement;

FIG. 7 shows a cross-sectional illustration of yet another exemplary embodiment of a fastening arrangement; and

FIG. 8 shows a cross-sectional illustration of yet another exemplary embodiment of a fastening arrangement.

### DESCRIPTION OF PREFERRED EMBODIMENTS

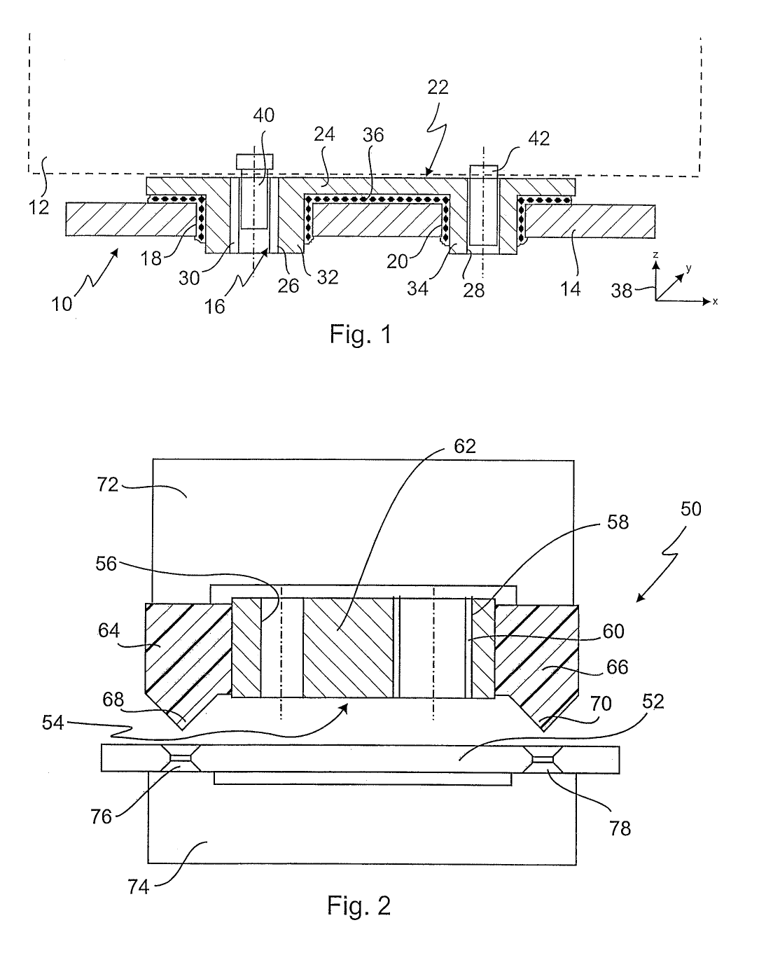

FIG. 1 illustrates a fastening arrangement, which is provided with the general reference number 10, for the positionally adjusted fastening of a device 12 to a structural part 14 of a motor vehicle (not illustrated) via at least one screw means 16.

The device 12 is, for example, a Head-up display, and the structural part 14 is preferably a portion or part of a cross member or a holder which is fastened to a cross member.

The structural part 14 is designed here as a plate in which there are two holes 18 and 20.

The fastening arrangement 10 furthermore has a tolerance-compensating part 22 which serves to compensate for tolerances, which are caused by manufacturing inaccuracies, of the structural part 14 in order to be able to fasten the device 12 in a positionally correct manner.

The tolerance-compensating part 22 is designed here as a substantially flat, plate-like crossbar 24 which has a first hole 26 and a second hole 28. A screw means in the form of a thread 30 is present in the hole 26, wherein the thread here is cut or roller burnished into the hole 26.

The tolerance-compensating part 22 has respective extensions 32 and 34 around the hole 26 and the hole 28, wherein the extension 32 is inserted into the hole 18 in the structural part 14 and the extension 34 is inserted into the hole 20 in the structural part 14.

Before the device 12 is fastened to the tolerance-compensating part 22, the tolerance-compensating part 22 has been fixed to the structural part 14 by means of a joining material 36. The joining material 36 here is an adhesive.

During the joining of the tolerance-compensating part 22 to the structural part 14, the tolerance-compensating part is adjusted in position relative to the structural part 14 in such a manner that, after the joining material 36 has solidified, the tolerance-compensating part 22 sits on the structural part 14 in a positionally correct manner.

It is optionally possible, by means of additional adjustment of the thickness of the layer of the joining material 36, which may also take place locally, for the tolerance-compensating part to be adjusted in position relative to the structural part 14 in three directions in space x, y, z, as illustrated by a system of coordinates 38 in FIG. 1.

During the joining of the tolerance-compensating part 22 to the structural part 14, joining material 36 is also introduced between the respective extensions 32 and 34 and the respective holes 18 and 20, as emerges from FIG. 1. For this purpose, the outside diameter of the respective extensions 32 and 34 is selected such that it is smaller than the inside diameter of the respective holes 18 and 20, in order to ensure that the tolerance-compensating part 22 is adjusted in position relative to the structural part 14 in the x-y plane.

The tolerance-compensating part 22 is therefore adjusted in position relative to the structural part 14 via the joining by means of the joining material 36, wherein it is possible, of course, for the layer of the joining material 36 to be of identical thickness or different thickness over the entire joining surface. During the joining operation, the tolerance-compensating part 22 is displaced or raised or tilted in a certain direction relative to the structural part 14 in order to ensure the subsequent correct position of the device 12 after the latter has been fastened to the tolerance-compensating part 22.

The device 12 is screwed to the screw means 16, here the internal thread of the hole 26 in the tolerance-compensating part 22, for example, by means of a screw 40 while a centring pin which is connected to the device 12 is inserted into the hole 28 in the tolerance-compensating part 22.

The device which is to be fastened in a manner adjusted in position is not illustrated in FIGS. 2 to 8 which are to be described below.

FIG. 2 illustrates a fastening arrangement 50 according to a further exemplary embodiment. The fastening arrangement 50 has a structural part 52 and a tolerance-compensating part 54.

The tolerance-compensating part 54 has a first hole 56 and a second hole 58, wherein the second hole 58 is provided with a screw means 60 which is designed in the form of a thread which is incorporated into the hole 58 in the tolerance-compensating part 54 by cutting or roller burnishing.

The thread 60 serves to receive a screw during the fastening of a device, and the hole 56 serves to receive a centring pin.

The tolerance-compensating part 54 is formed by a central, preferably metallic, plate-like crossbar 62, at both ends of which a plastics body 64 or 66 is connected fixedly to the crossbar 62. As an alternative, a single plastics body surrounding the plate-like crossbar 62 circumferentially may also be provided.

Before the tolerance-compensating part 54 is fastened to the structural part 52, the plastics bodies 64 and 66 respectively have ends 68 and 70 which each converge substantially to a point.

In order to fasten the tolerance-compensating part 54 to the structural part 52, use is made here of a joining process which consists in ultrasonic welding of the plastic of the ends 68 and 70 of the plastics bodies 64 and 66.

FIG. 2 shows a sonotrode 72 and an anvil 74, between which the tolerance-compensating part 54 and the structural part 52 are arranged. By means of the application of ultrasound, the plastic in the region of the ends 68 and 70 of the plastics bodies 64 and 66 liquefies and, in the process, flows into non-cylindrical holes 76 and 78 in the structural part 52 in a form-fitting manner. The holes 76 and 78 are of hour-glass-shaped design here. Even in the case in which, instead of the plastics bodies 64, 66 at the end sides, there is one plastics body encircling the crossbar 62 circumferentially, there are only the two holes 76 and 78, or a plurality of local holes, into which the plastic flows.

In this case, too, during the joining by means of the joining material, i.e. the plastic of the ends 68 and 70, which flows into the holes 76 and 78, the tolerance-compensating part 54 is adjusted in position in a positionally correct manner relative to the structural part 52.

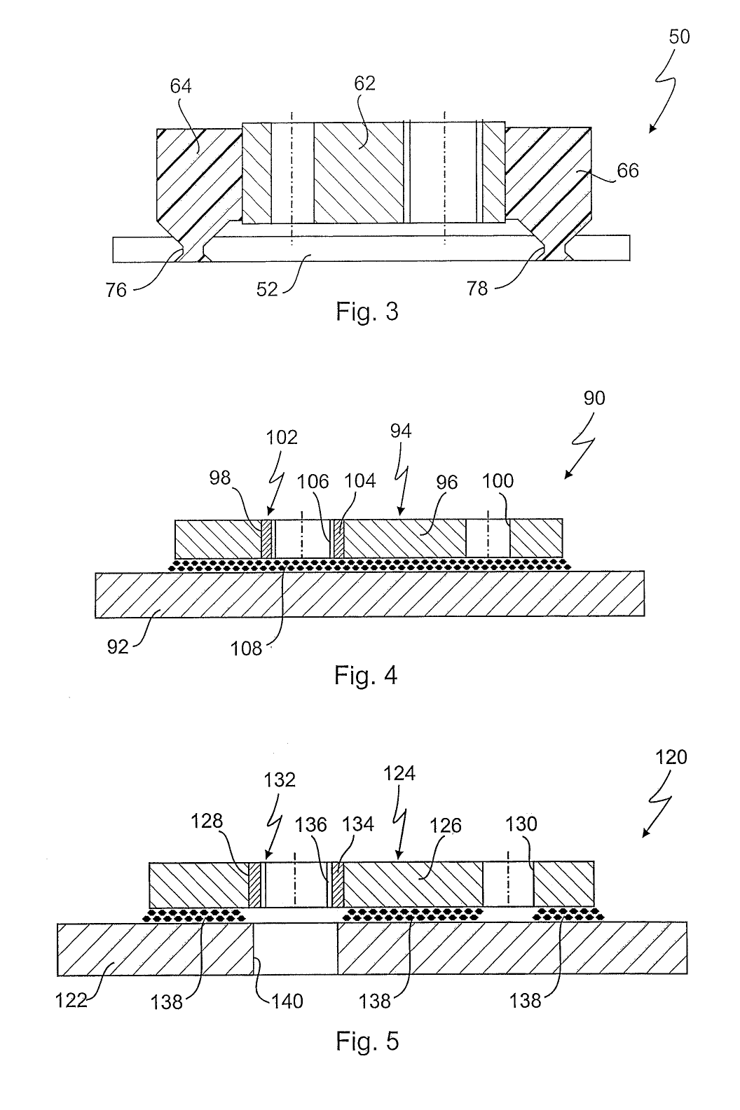

FIG. 3 shows the finished state of the fastening arrangement 50.

FIG. 4 illustrates a further exemplary embodiment of a fastening arrangement 90 for the positionally correct fastening of a device (not illustrated) to a structural part 92 of a motor vehicle (not illustrated) via at least one screw means 102.

The fastening arrangement 90 has a tolerance-compensating part 94 which, in the exemplary embodiment shown, is designed entirely as a flat, plate-like crossbar 96.

Two holes 98 and 100 have been introduced into the crossbar 96.

In the exemplary embodiment shown, the screw means 102 is formed by a sleeve or nut 104 which has an internal thread 106 for the screwing-in of a screw (not illustrated) for fastening the device.

In this case, the sleeve 104 with the internal thread 106 is inserted into the hole 98 by any method, for example by adhesive bonding, welding, pressing and the like.

The structural part 92 does not have a hole in the exemplary embodiment shown here, and the tolerance-compensating part 94 is adhesively bonded in a sheet-like manner onto the structural part 92 over the entire surface of the crossbar 96 via a joining material 108, here an adhesive. Here too, again, the tolerance-compensating part 94 is oriented and positioned in a positionally correct manner relative to the structural part 92 during the joining by means of the joining material 108 so that the device which is to be attached later is likewise positioned in a positionally correct manner when it is fastened to the tolerance-compensating part 94 via the screw means 102. In this case, the thickness of the layer of the joining material 108 can also be adjusted differently along the joining surface in order to permit an adjustment of the position in all three directions in space x, y and z.

FIG. 5 shows a further exemplary embodiment of a fastening arrangement 120 for the positionally correct fastening of a device (not illustrated) to a structural part 122 of a motor vehicle (not illustrated).

The fastening arrangement 120 has a tolerance-compensating part 124 which, as in the previous exemplary embodiment, is designed as a completely planar, plate-like crossbar 126 with a first hole 128 and a second hole 130.

A screw means 132 which, as in the preceding exemplary embodiment, is formed by a sleeve 134, which is provided with an internal thread 136, is arranged in the hole 128. The sleeve 134 is inserted into the hole 128 and is fixed to the crossbar 126 in any suitable way as described previously with respect to the sleeve 104.

The tolerance-compensating part 124 is fastened in a manner adjusted in position to the structural part 122 by means of a joining material 138. By means of additional adjustment of the thickness of the joining material 138 between the tolerance-compensating part 124 and the structural part 122, the tolerance-compensating part 124 can also be positioned in a positionally correct manner relative to the structural part 122 in the z direction.

In contrast to the preceding exemplary embodiment, the joining material 138 is present only in sections rather than continuously in the gap between the tolerance-compensating part or the crossbar 126 and the structural part 122. As emerges from FIG. 5, there is no joining material in the region of the hole 128 and in the region of the hole 130 between the tolerance-compensating part 124 and the structural part 122.

In the exemplary embodiment shown in FIG. 5, the structural part 122 furthermore has a hole 140 which is aligned with the hole 128 in the tolerance-compensating part 124. This makes it possible for a screw, with which the device (not illustrated) is fastened to the tolerance-compensating part 124, to project into the hole 140.

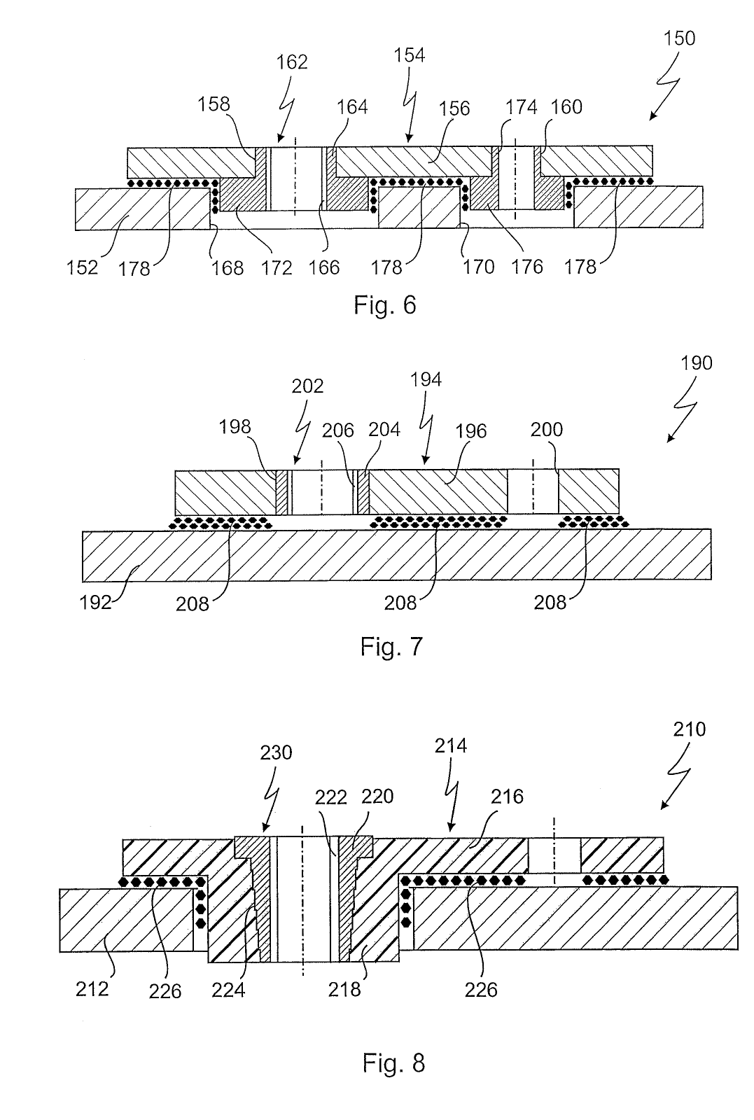

FIG. 6 shows a further exemplary embodiment of a fastening arrangement 150 for the positionally correct fastening of a device (not illustrated) to a structural part 152 of a motor vehicle (not illustrated) via at least one screw means 162.

The fastening arrangement 150 has a tolerance-compensating part 154 which is designed as a planar, plate-like crossbar 156 with a first hole 158 and a second hole 160.

The screw means 162 is formed by a sleeve 164 with an internal thread 166, which sleeve is inserted into the hole 158 and is fixed there as described above.

The structural part 152 has a hole 168 and a hole 170, similarly to the structural part 14 in FIG. 1.

The sleeve 164, which has the internal thread 166, has a portion 172 which is inserted into the hole 168 in the structural part 152, wherein the portion 172 has an outside diameter which is smaller than the inside diameter of the hole 168.

A further sleeve 174 which is designed without an internal thread and serves to receive the centring pin (already mentioned above) of the device which is to be fastened is inserted into the hole 160. The sleeve 174 also has a portion 176, the outside diameter of which is smaller than the inside diameter of the hole 170, the portion 176 being inserted into the hole 70 in the structural part 152.

The tolerance-compensating part 154 is joined to the structural part 152 by means of a joining material 178, the joining material 178, here an adhesive, also being present between the respective portions 172 and 176 of the sleeves 164 and 174 and the respective holes 168 and 170.

In the case of the fastening arrangement 150 too, the tolerance-compensating part 154 is adjusted in position relative to the structural part 152 during the joining by means of the joining material 178 with the effect of optimally compensating for manufacturing tolerances of the structural part 152 including the holes 168 and 170 thereof.

FIG. 7 shows a fastening arrangement 190 for the positionally adjusted fastening of a device (not illustrated) to a structural part 192 of a motor vehicle (not illustrated).

The fastening arrangement 190 has a tolerance-compensating part 194 which is designed as an overall planar crossbar 196 with a first hole 198 and a second hole 200. A screw means 202 is arranged in the hole 198, said screw means being formed by a sleeve 204 which is provided with an internal thread 206 and is inserted fixedly in the hole 198.

The fastening arrangement 190 differs from the fastening arrangement 90 in FIG. 4 in that the tolerance-compensating part 194 is joined to the structural part 192 via a joining material 208, here an adhesive, but the joining material 208 is not present between the tolerance-compensating part 194 and the structural part 192 in the region of the hole 198 and the hole 200.

Whereas, in the previously described fastening arrangements, the respective tolerance-compensating part is preferably manufactured from metal, but may also be manufactured from plastic, FIG. 8 shows a fastening arrangement 210 which has a tolerance-compensating part which is manufactured from plastic as below.

The fastening arrangement 210 has a structural 212 and a tolerance-compensating part 214.

As already mentioned, the tolerance-compensating part 214 is manufactured from plastic and has a planar, plate-like crossbar 216 and an extension 218 which is designed as a single piece with the crossbar 216, similarly to the configuration of the tolerance-compensating part 22 in FIG. 1.

The tolerance-compensating part 214 has a screw means 230 which is designed in the form of a sleeve or nut 220 with an internal thread 222. In this case, the sleeve or nut 220 is cast into the plastic of the tolerance-compensating part 214 during the production of the latter, the sleeve 220 being provided on the outside with a textured structure 224, for example a ribbing or a toothing or another structure, as a result of which the sleeve 220 is held in the tolerance-compensating part 214 in a manner secure against rotation.

The tolerance-compensating part 214 is joined by means of a joining material 226, here an adhesive, the tolerance-compensating part 214 being brought, during the joining operation, into the correct position and orientation relative to the structural part 212 such that the device which is to be attached to the tolerance-compensating part 214 is likewise positioned and oriented in a positionally correct manner once said device has been fastened.

The previously described fastening arrangements 10, 50, 90, 120, 150, 190, 210 also make it possible to fasten the tolerance-compensating part to the structural part in a manner adjusted in position even before the structural part is installed on or in the vehicle, and therefore, after the arrangement consisting of the structural part and tolerance-compensating part has been installed, the corresponding device merely has to be fitted to the tolerance-compensating part, which has been adjusted in a positionally correct manner, without the device itself having to be subjected to a further complicated adjustment.

What is claimed is:

1. A method for the positionally correct fastening of a device to a structural part of a motor vehicle, comprising the following steps:
providing the device;
providing the structural part;
providing a tolerance-compensating part;
joining the tolerance-compensating part to the structural part by making use of a joining process in which a joining material is used, the joining process being selected from the group consisting of: adhesive bonding with an adhesive as the joining material, ultrasonic welding with a plastic as the joining material;
positionally adjusting the tolerance-compensating part relative to the structural part during the joining process through the joining material;
fastening the device to the tolerance-compensating part via at least one screw.

2. The method claim 1, further comprising positionally adjusting the tolerance-compensating part relative to the structural part in at least two directions in space.

3. The method of claim 1, further comprising positionally adjusting the tolerance-compensating part relative to the structural part in three directions in space.

4. The method of claim 1, wherein the step of positionally adjusting the tolerance-compensating part relative to the structural part further comprises adjusting a thickness of a layer formed from the joining material between the tolerance-compensating part and the structural part.

5. A fastening arrangement for the positionally correct fastening of a device to a structural part of a motor vehicle, comprising a device;
a structural part;
a tolerance-compensating part fixed to the structural part a joining material which is selected from the group consisting of: an adhesive, a plastic liquefied by ultrasonic welding, the tolerance-compensating part being adjusted in position relative to the structural part by the joining material;
at least one screw fastening the device to the tolerance-compensating part.

6. The fastening arrangement of claim 5, wherein the tolerance-compensating part is adjusted by a thickness of a layer formed by the joining material between the tolerance-compensating part and the structural part.

7. The fastening arrangement of claim 5, wherein the tolerance-compensating part has a hole having a thread which is cut or roller burnished into the hole in the tolerance-compensating part, the at least one screw being screwed into the thread.

8. The fastening arrangement of claim 5, wherein the tolerance-compensating has a hole and a sleeve provided with an internal thread, the sleeve being at least one of inserted into the hole in the tolerance-compensating part and cast into the tolerance-compensating part, the at least one screw being screwed into the thread.

9. The fastening arrangement of claim 8, wherein the sleeve has a portion which is inserted into a hole of the structural part, wherein the portion has an outside diameter which is smaller than an inside diameter of the hole of the structural part, the joining material being also present between the portion of the sleeve and the hole of the structural part.

10. The fastening arrangement of claim 5, wherein the tolerance-compensating part is a substantially flat, plate-like crossbar.

11. The fastening arrangement of claim 5, wherein the tolerance-compensating part has an extension inserted into a hole of the structural part, the extension having an outside diameter which is smaller than an inside diameter of the hole of the structural part, the joining material being also present between the extension and the hole of the structural part.

12. The fastening arrangement of claim 5, wherein the tolerance-compensating part is made of plastic.

13. The fastening arrangement of claim 5, wherein the tolerance-compensating part is made of metal.

14. The fastening arrangement of claim 5, wherein the device is a Head-up display.

15. The fastening arrangement of claim 5, wherein the structural part is selected from the group consisting of: a cross member of a motor vehicle, a cross member part of a motor vehicle, a holder fastened to a crossmember of a motor vehicle.
